(19) United States
(12) Patent Application Publication
(10) Pub. No.: US 2025/0260067 A1
(43) Pub. Date: Aug. 14, 2025

(54) METHOD OF MANUFACTURING SOLID-STATE SECONDARY BATTERY

(71) Applicant: HONDA MOTOR CO., LTD., Tokyo (JP)

(72) Inventors: Takashi NAKAGAWA, Saitama (JP); Kyohei IZUMI, Saitama (JP)

(21) Appl. No.: 19/048,988

(22) Filed: Feb. 10, 2025

(30) Foreign Application Priority Data
Feb. 14, 2024 (JP) 2024-020714

(51) Int. Cl. H01M 10/0587; H01M 4/02; H01M 4/36; H01M 4/62

(52) U.S. Cl. CPC H01M 10/0587; H01M 4/366; H01M 4/625; H01M 2004/021; H01M 2004/027; H01M 2004/028

(57) ABSTRACT

A method of manufacturing a solid-state secondary battery according to one embodiment of the present invention includes a first joining step of press-joining a positive electrode active material layer and a solid electrolyte layer to obtain a positive electrode layer-solid electrolyte layer assembly, a second joining step of press-joining the solid electrolyte layer and an intermediate layer in the positive electrode layer-solid electrolyte layer assembly to obtain a positive electrode layer-solid electrolyte layer-intermediate layer assembly, a densifying step of press-molding the positive electrode layer-solid electrolyte layer-intermediate layer assembly in a thickness direction so that a porosity of each of the positive electrode active material layer and the solid electrolyte layer is 5% or less, and a third joining step of press-joining the intermediate layer in the positive electrode layer-solid electrolyte layer-intermediate layer assembly, and the negative electrode layer to obtain an electrode laminate.

This application is based on and claims the benefit of priority from Japanese Patent Application No. 2024-020714, filed on 14 Feb. 2024, the content of which is incorporated herein by reference.

### BACKGROUND OF THE INVENTION

### Field of the Invention

The present invention relates to a method of manufacturing a solid-state secondary battery.

### Related Art

In recent years, research and development has been carried out on secondary batteries that contribute to energy efficiency in order for more people to be able to ensure access to energy that is reasonable, reliable, sustainable, and advanced. Among secondary batteries, solid-state secondary batteries including an electrode laminate in which a solid electrolyte layer is placed between a positive electrode layer and a negative electrode layer have particularly attracted attention since they are excellent in terms of improved safety thanks to non-flammable solid electrolytes and have higher energy density. To improve the characteristics of the solid-state secondary battery, studies are underway to provide an intermediate layer between a solid electrolyte layer and a negative electrode layer. For example, studies are underway to place a protective layer as an intermediate layer, the protective layer being more stable in reductive decomposition than the solid electrolyte, and having a shearing modulus of elasticity of 2 GPa or more, the shearing modulus of elasticity differing by 50 GPa or less from the shearing modulus of elasticity of the solid electrolyte layer (Patent Document 1).
Patent Document 1: Japanese Unexamined Patent Application, Publication No. 2022-186164

### SUMMARY OF THE INVENTION

Incidentally, in the solid-state secondary battery, it has been desired to increase charge and discharge capacity. To increase the charge and discharge capacity in the solid-state secondary battery, studies are underway to use lithium as a negative electrode active material and to densify a positive electrode active material layer of a positive electrode layer and a solid electrolyte layer in an electrode laminate. However, in a case where a joining force between the positive electrode active material layer of the positive electrode layer and the solid electrolyte layer or a joined area therebetween is narrow even when the positive electrode active material layer and the solid electrolyte layer are densified, an internal resistance of the electrode laminate increases and an internal short circuit occurs due to electric current concentration, which may cause a decrease in charge and discharge capacity.

The present invention has been made in view of the above-described circumstances, and an object thereof is to provide a method capable of industrially advantageously manufacturing a solid-state secondary battery having a low internal resistance and a high charge and discharge capacity. Consequently, the solid-state secondary battery contributes to energy efficiency.

The present inventors have found that the above-described problems can be solved by, in a method of manufacturing an electrode laminate including an intermediate layer between a negative electrode layer and a solid electrolyte layer, joining the intermediate layer and the negative electrode layer after press-molding, in a thickness direction, an assembly obtained by press-joining a positive electrode layer, the negative electrode layer, and the intermediate layer to densify the positive electrode layer, and the solid electrolyte layer, thereby completing the present invention. Thus, the present invention provides the following aspects.

A first aspect of the present invention relates to a method of manufacturing a solid-state secondary battery including an electrode laminate that includes a positive electrode layer including a positive electrode current collector and a positive electrode active material layer, a negative electrode layer including a negative electrode current collector facing the positive electrode active material layer, a solid electrolyte layer placed between the positive electrode layer and the negative electrode layer, and an intermediate layer placed between the negative electrode layer and the solid electrolyte layer, each of the positive electrode layer, the solid electrolyte layer, the intermediate layer, and the negative electrode layer being joined to an adjacent layer, the method including: a first joining step of press-joining the positive electrode active material layer and the solid electrolyte layer to obtain a positive electrode layer-solid electrolyte layer assembly, a second joining step of press-joining the solid electrolyte layer and the intermediate layer in the positive electrode layer-solid electrolyte layer assembly to obtain a positive electrode layer-solid electrolyte layer-intermediate layer assembly, a densifying step of press-molding the positive electrode layer-solid electrolyte layer-intermediate layer assembly in a thickness direction to densify the assembly, and a third joining step of press-joining the intermediate layer in the positive electrode layer-solid electrolyte layer-intermediate layer assembly, and the negative electrode layer to obtain the electrode laminate, in which a porosity of each of the positive electrode active material layer and the solid electrolyte layer after the third joining step is 5% or less.

In the method of manufacturing a solid-state secondary battery of the first aspect, the positive electrode layer-solid electrolyte layer-intermediate layer assembly obtained in the second joining step is press-molded in the thickness direction to be densified in the densifying step, and the adhesion at the contact interface of each layer of the positive electrode active material layer, the solid electrolyte layer, and the intermediate layer is enhanced. The positive electrode active material layer after the third joining step has a porosity that falls within the range described above and has a high density, and thus the electric capacity is increased. Furthermore, the solid electrolyte layer after the third joining step has a porosity that falls within the range described above and has a high density, and thus the conductivity for charge transfer media is enhanced. Therefore, the solid-state secondary battery thus obtained has a lower internal resistance, thus achieving a higher charge and discharge capacity.

A second aspect of the present invention relates to the method of manufacturing a solid-state secondary battery described in the first aspect, in which a press-molding pressure in the densifying step is higher than a press-joining pressure in each of the first joining step, the second joining step, and the third joining step.

According to the method of manufacturing a solid-state secondary battery of the second aspect, the press-molding pressure in the densifying step is high, and thus in the densifying step, the porosity of each layer of the positive electrode active material layer, the solid electrolyte layer, and the intermediate layer is further reduced and the adhesion at the contact interface of each layer is further enhanced. Therefore, the solid-state secondary battery thus obtained has a lower internal resistance, thus achieving a higher charge and discharge capacity.

A third aspect of the present invention relates to the method of manufacturing a solid-state secondary battery described in the first or second aspect, in which a press-joining pressure in the second joining step is higher than a press-joining pressure in the first joining step.

According to the method of manufacturing a solid-state secondary battery of the third aspect, in the first joining step, the press-joining pressure is lowered, and the positive electrode layer and the solid electrolyte layer in the positive electrode layer-solid electrolyte layer assembly are softened to leave a pressing margin, and in the second joining step, the press-joining pressure is increased, whereby a contact area between the solid electrolyte layer and the intermediate layer is increased in a state in which the intermediate layer is soft and has appropriate pores, enabling the adhesion to be enhanced. The intermediate layer in a soft state and with appropriate pores makes it easy to uniformly transfer the charge transfer media toward the entire surface of the negative electrode during charging.

A fourth aspect of the present invention relates to the method of manufacturing a solid-state secondary battery described in any one of the first to third aspects, in which a press-joining pressure in the third joining step is higher than a press-joining pressure in the first joining step and is lower than a press-joining pressure in the second joining step.

According to the method of manufacturing a solid-state secondary battery of the fourth aspect, the press-joining pressure in the third joining step falls within the range described above, and thus the intermediate layer and the negative electrode layer can be joined to each other without excessively applying the pressure to the intermediate layer, making it possible to maintain the intermediate layer in a state of being soft and having appropriate pores. The collapse of the structure of the positive electrode layer and the solid electrolyte layer can be suppressed, thus achieving short circuit prevention and internal resistance reduction.

A fifth aspect of the present invention relates to the method of manufacturing a solid-state secondary battery described in any one of the first to fourth aspects, in which a rate of decrease in porosity of the positive electrode active material layer by press-molding in the densifying step is 77% or more, and a rate of decrease in porosity of the solid electrolyte layer by the press-molding is 85% or more. The rate of decrease in porosity is a value calculated by the following equation (1).

$$Rate of decrease in porosity ( \% ) = ( porosity before densifying step - porosity after densifying step ) / porosity before densifying step \times 100 \qquad ( 1 )$$

According to the method of manufacturing a solid-state secondary battery of the fifth aspect, after the densifying step, the rate of decrease in porosity of the positive electrode active material layer and the rate of decrease in porosity of the solid electrolyte layer fall within the respective ranges described above, and thus the positive electrode active material layer and the solid electrolyte layer each have a high density. Therefore, an effective reaction area in the positive electrode active material layer and the solid electrolyte layer increases, causing the adhesion of each layer interface to be enhanced, and thus the solid-state secondary battery thus obtained has a lower internal resistance, thus achieving a higher charge and discharge capacity.

A sixth aspect of the present invention relates to the method of manufacturing a solid-state secondary battery described in any one of the first to fifth aspects, in which a press-molding temperature in the densifying step falls within a range of 60° C. or more and 200° C. or less.

According to the method of manufacturing a solid-state secondary battery of the sixth aspects, the press-molding temperature in the densifying step falls within the range described above, and thus in the densifying step, the porosity of each layer of the positive electrode active material layer, the solid electrolyte layer, and the intermediate layer is further reduced, and the adhesion at the contact interface of each layer is enhanced more reliably. Therefore, the solid-state secondary battery thus obtained has a lower internal resistance, thus achieving a higher charge and discharge capacity.

A seventh aspect of the present invention relates to the method of manufacturing a solid-state secondary battery described in any one of the first to sixth aspects, in which the press-molding in the densifying step is performed by an isostatic press method.

According to the method of manufacturing a solid-state secondary battery of the seventh aspect, the press-molding in the densifying step is performed by the isostatic press method, and thus in the densifying step, the porosity of each layer of the positive electrode active material layer, the solid electrolyte layer, and the intermediate layer is uniformly reduced, and the adhesion at the contact interface of each layer is uniformly enhanced. Therefore, the solid-state secondary battery thus obtained has a lower internal resistance, thus achieving a higher charge and discharge capacity.

An eighth aspect of the present invention relates to the method of manufacturing a solid-state secondary battery described in any one of the first to seventh aspect, in which a composite modulus of elasticity of the intermediate layer in the positive electrode layer-solid electrolyte layer-intermediate layer assembly after the densifying step is less than 1 GPa.

According to the method of manufacturing a solid-state secondary battery of the eighth aspect, the composite modulus of elasticity of the intermediate layer in the positive electrode layer-solid electrolyte layer-intermediate layer assembly after the densifying step falls within the range described above, the intermediate layer is soft, and thus a contact area of each of an interface between the solid electrolyte layer and the intermediate layer and an interface between the intermediate layer and the negative electrode layer increases, enabling the adhesion to be enhanced. The intermediate layer follows the expansion and contraction of the negative electrode layer during charging and discharging, so that the positive electrode layer and the negative electrode layer can perform a uniform reaction in an in-plane direction and a thickness direction. Therefore, the solid-state secondary battery thus obtained can have a lower internal resistance, and can achieve current concentration suppression and short circuit prevention.

A ninth aspect of the present invention relates to the method of manufacturing a solid-state secondary battery described in any one of the first to eighth aspects, in which a porosity of the intermediate layer in the positive electrode layer-solid electrolyte layer-intermediate layer assembly after the densifying step falls within a range of 40% or more and 70% or less.

According to the method of manufacturing a solid-state secondary battery of the ninth aspect, the porosity of the intermediate layer in the positive electrode layer-solid electrolyte layer-intermediate layer assembly after the densifying step falls within the range described above, and thus an electrode laminate in which the intermediate layer has pores can be obtained. The intermediate layer having pores is flexible, and thus the intermediate layer can follow changes in the thickness of the negative electrode layer during charging and discharging. Therefore, in the solid-state secondary battery thus obtained, the internal resistance is stably reduced, thus achieving a stably high charge and discharge capacity.

A tenth aspect of the present invention relates to the method of manufacturing a solid-state secondary battery described in any one of the first to ninth aspects, in which the intermediate layer includes amorphous carbon particles.

According to the method of manufacturing a solid-state secondary battery of the tenth aspect, the intermediate layer includes amorphous carbon particles, and thus the conductivity for charge transfer media in the intermediate layer is enhanced. Therefore, the solid-state secondary battery thus obtained has a lower internal resistance, thus achieving a more stably high charge and discharge capacity.

The present invention makes it possible to industrially advantageously manufacture a solid-state secondary battery having a low internal resistance and a high charge and discharge capacity.

### BRIEF DESCRIPTION OF THE DRAWINGS

FIG. 1 is a sectional view illustrating an example of a solid-state secondary battery obtained by a method of manufacturing a solid-state secondary battery according to one embodiment of the present invention;

FIG. 2 is a diagram illustrating one step of a method of manufacturing the solid-state secondary battery according to one embodiment of the present invention, the diagram being a sectional view illustrating a state in which the positive electrode layer and the solid electrolyte layer are press-joined to each other;

FIG. 3 is a diagram illustrating one step of a method of manufacturing the solid-state secondary battery according to one embodiment of the present invention, the diagram being a sectional view illustrating a state in which the solid electrolyte layer and the intermediate layer are press-joined to each other; and

FIG. 4 is a diagram illustrating one step of a method of manufacturing the solid-state secondary battery according to one embodiment of the present invention, the diagram being a sectional view illustrating a state in which the intermediate layer and the negative electrode layer are press-joined to each other.

### DETAILED DESCRIPTION OF THE INVENTION

Embodiments of the present invention will be described below with reference to the drawings. It should be noted, however, that the embodiments below are illustrative of the present invention, and the present invention is not limited to the following description.

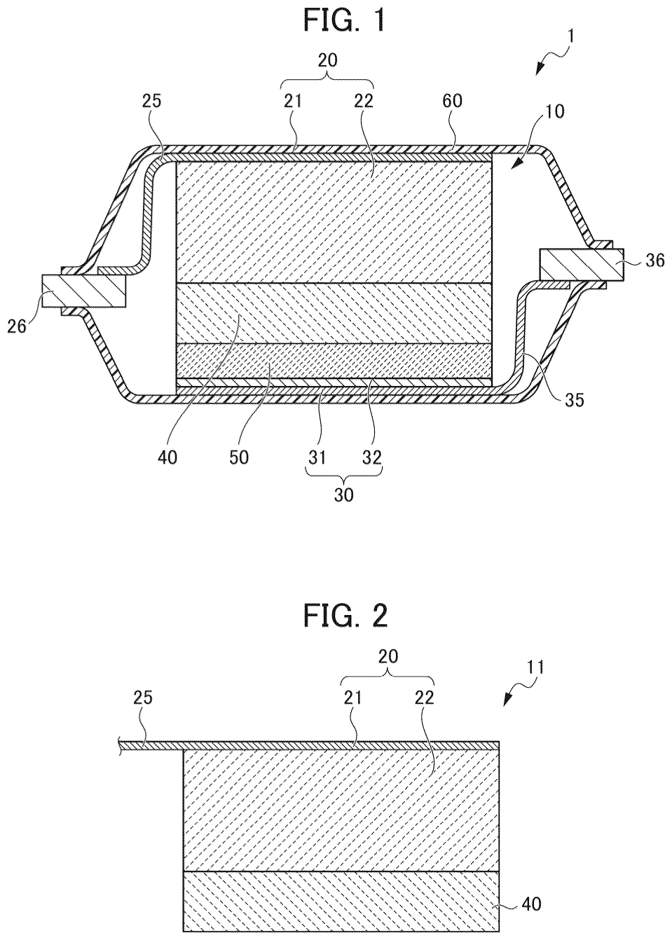

FIG. 1 is a sectional view illustrating one example of a solid-state secondary battery obtained by a method of manufacturing a solid-state secondary battery according to one embodiment of the present invention. As illustrated in FIG. 1, a solid-state secondary battery 1 includes an electrode laminate 10, and an exterior housing body 60 housing the electrode laminate 10.

The electrode laminate 10 is a laminate including a positive electrode layer 20, a negative electrode layer 30, a solid electrolyte layer 40 placed between the positive electrode layer 20 and the negative electrode layer 30, and an intermediate layer 50 placed between the negative electrode layer 30 and the solid electrolyte layer 40. The positive electrode layer 20 includes a positive electrode current collector 21, and a positive electrode active material layer 22 laminated on one surface (lower surface in FIG. 1) of the positive electrode current collector 21. The positive electrode current collector 21 is connected to a positive electrode terminal 26 via a positive electrode lead wire 25. The negative electrode layer 30 includes a negative electrode current collector 31, and a metal layer 32 laminated on a surface on the solid electrolyte layer 40 side of the negative electrode current collector 31. The negative electrode current collector 31 is connected to a negative electrode terminal 36 via a negative electrode lead wire 35. The negative electrode current collector 31 faces the positive electrode active material layer 22. Each of the positive electrode layer 20, the solid electrolyte layer 40, the intermediate layer 50, and the negative electrode layer 30 is joined to an adjacent layer. Parts of the positive electrode terminal 26 and the negative electrode terminal 36 are exposed from the exterior housing body 60. The solid-state secondary battery 1 illustrated in FIG. 1 is in a discharged state. When the solid-state secondary battery 1 is charged, lithium ions serving as charge transfer media released from the positive electrode active material layer 22 pass through the solid electrolyte layer 40 and the intermediate layer 50, and are deposited on the surface of the metal layer 32 of the negative electrode layer 30 to generate a lithium deposited layer, resulting in an increase in thickness of the negative electrode layer 30. By passing the lithium ions through the intermediate layer 50, the lithium deposited layer can be uniformly generated on the surface of the metal layer 32. The lithium deposited layer serves as the negative electrode active material, and releases lithium ions during discharging. Therefore, in the solid-state secondary battery 1, the thickness of the negative electrode layer 30 changes due to charging and discharging.

The positive electrode active material layer 22, the solid electrolyte layer 40, and the intermediate layer 50 in the electrode laminate 10 have pores. A porosity of each of the positive electrode active material layer 22 and the solid electrolyte layer 40 is 5% or less. A porosity of each of the positive electrode active material layer 22 and the solid electrolyte layer 40 may also be 3% or less. The porosity of the intermediate layer 50 may be larger than that of each of the positive electrode active material layer 22 and the solid electrolyte layer 40. The porosity of the intermediate layer 50 may, for example, fall within a range of 10 times or more and 40 times or less with respect to the porosity of each of the positive electrode active material layer 22 and the solid electrolyte layer 40. The porosity of the intermediate layer 50 may also, for example, fall within a range of 40% or more and 70% or less. The porosity may be, for example, a value calculated from a volume-based filling rate (%) of the intermediate layer 50 using the following equation (2), the filling rate being obtained by measuring a weight, an area, and a film thickness of the material constituting the intermediate layer 50. The porosity is a value measured during a period after the electrode laminate 10 is manufactured and before the electrode laminate 10 is charged or discharged.

$$Porosity ( \% ) = 100 - filling rate ( \% ) \qquad ( 2 )$$

The method of calculating the “filling rate” in equation (2) is not limited to the above-described method. The filling rate may be a percentage of a density of the molded intermediate layer 50 with respect to the true density of the material constituting the intermediate layer 50. Furthermore, the filling rate may be calculated from the pore volume measured by an instrumental analysis by the BET method, the porosimeter method, or the gas diffusion method, for example. Alternatively, the filling rate may be calculated by an image analysis using a scanning electron microscope, or the like.

A composite modulus of elasticity of each layer of the positive electrode active material layer 22, the solid electrolyte layer 40, the intermediate layer 50, and the metal layer 32 in the electrode laminate 10 may satisfy a relationship of intermediate layer 50<metal layer 32<solid electrolyte layer 40<positive electrode active material layer 22, for example. The composite modulus of elasticity of the intermediate layer 50 may fall, for example, within a range of 0.1 GPa or more and 2.0 GPa or less. The composite modulus of elasticity of the metal layer 32 may fall, for example, within a range of 2 times or more and 10 times or less with respect to the composite modulus of elasticity of the intermediate layer 50. The composite modulus of elasticity of the metal layer 32 may fall, for example, within a range of 1.0 GPa or more and 4.0 GPa or less. The composite modulus of elasticity of the solid electrolyte layer 40 may fall, for example, within a range of 5 times or more and 20 times or less with respect to the composite modulus of elasticity of the metal layer 32. The composite modulus of elasticity of the solid electrolyte layer 40 may fall, for example, within a range of 10 GPa or more and 50 GPa or less. The composite modulus of elasticity of the positive electrode active material layer 22 may fall, for example, within a range of 2 times or more and 5 times or less with respect to the composite modulus of elasticity of the solid electrolyte layer 40. The composite modulus of elasticity of the positive electrode active material layer 22 may fall, for example, within a range of 50 GPa or more and 200 GPa or less. The composite modulus of elasticity is a value measured by the nanoindentation method. The composite modulus of elasticity is a value measured from after the manufacture of the electrode laminate 10 until before the electrode laminate 10 is charged and discharged.

The positive electrode current collector 21 may have any material and shape as long as it has the function of collecting current from the positive electrode layer 20. Examples of the material of the positive electrode current collector 21 include aluminum, an aluminum alloy, stainless steel, nickel, iron, and titanium, and among them, aluminum, an aluminum alloy, and stainless steel are preferable. Examples of the shape of the positive electrode current collector 21 include a foil shape, and a plate shape.

The positive electrode active material layer 22 contains at least one type of positive electrode active material. The positive electrode active material is not limited to particular one, and a positive electrode active material which is used in the positive electrode layer in a general solid-state secondary battery can be used. Examples of the positive electrode active material which can be used include a lithium-containing layered active material, a spinel-type active material, and an olivine-type active material. Specific examples of the positive electrode active material include lithium cobalt oxide (LiCoO₂), lithium nickel oxide (LiNiO₂), LiNiₚMn_{q}CoᵣO₂ (p+q+r=1), LiNiₚAl_{q}CoᵣO₂ (p+q+r=1), lithium manganate (LiMn₂O₄), a different element substituted Li—Mn spinel represented by Li₁₊ₓMn_{2-x-y}MO₄ (x+Y=2, M=at least one selected from Al, Mg, Co, Fe, Ni, and Zn), lithium titanate (oxide including Li and Ti), and lithium metal phosphate (LiMPO₄, M=at least one selected from Fe, Mn, Co and Ni).

The average particle size of the positive electrode active material may fall, for example within a range of 0.5 μm or more and 20 μm or less. In the present embodiment, the average particle size is a value measured by the laser diffraction and scattering method.

In terms of enhancing the conductivity for lithium ions, the positive electrode active material layer 22 may arbitrarily include a solid electrolyte. The positive electrode active material layer 22 may arbitrarily include a conductive aid to enhance the conductivity. Furthermore, in terms of developing the flexibility, the positive electrode active material layer 22 may arbitrarily include a binder. The solid electrolyte, the conductive aid, and the binder are not limited to particular ones, and a solid electrolyte, a conductive aid, and a binder which are used in the positive electrode layer in a general solid-state secondary battery can be used.

The positive electrode lead wire 25 may be made of the same material as the positive electrode current collector 21, or may be made of a material different from the positive electrode current collector 21. The positive electrode lead wire 25 may be integrally connected to the positive electrode current collector 21. In the present embodiment, the positive electrode lead wire 25 is formed as an extension of the positive electrode current collector 21, and is integrally connected to the positive electrode current collector 21. The positive electrode terminal 26 may be made of the same material as the positive electrode lead wire 25, or may be made of a material different from the positive electrode lead wire 25. The positive electrode terminal 26 may be integrally connected to the positive electrode lead wire 25. In the present embodiment, the positive electrode terminal 26 and the positive electrode lead wire 25 are different members electrically connected to each other.

The negative electrode current collector 31 may have any material and shape as long as it has the function of collecting current from the negative electrode layer 30. Examples of the material of the negative electrode current collector 31 include nickel, copper, and stainless steel. Examples of the shape of the negative electrode current collector 31 include a foil shape, and a plate shape.

The metal layer 32 may have any material and shape as long as it has the function of densely depositing lithium ions. As the metal layer 32, metallic lithium layer or a layer of metal which generates an alloy with lithium can be used. Examples of the metal which forms an alloy with lithium include Mg, Si, Au, Ag, In, Ge, Sn, Pb, Al, and Zn. The metal which forms the metal layer 32 may be in the shape of powder or may be in the shape of a thin film. The negative electrode layer 30 which includes this metal layer 32 is used, and thus the lithium deposited layer can be uniformly generated on the surface of the metal layer 32.

The negative electrode lead wire 35 may be made of the same material as the negative electrode current collector 31, or may be made of a material different from the negative electrode current collector 31. The negative electrode lead wire 35 may be integrally connected to the negative electrode current collector 31. In the present embodiment, the negative electrode lead wire 35 is formed as an extension of the negative electrode current collector 31, and is integrally connected to the negative electrode current collector 31. The negative electrode terminal 36 may be made of the same material as the negative electrode lead wire 35, or may be made of a material different from the negative electrode lead wire 35. The negative electrode terminal 36 may be integrally connected to the negative electrode lead wire 35. In the present embodiment, the negative electrode terminal 36 and the negative electrode lead wire 35 are different members electrically connected to each other.

The solid electrolyte layer 40 contains at least one type of solid electrolyte. The solid electrolyte layer 40 can conduct the lithium ions between the positive electrode layer 20 and the negative electrode layer 30 via the solid electrolyte.

Although the solid electrolyte is not limited to particular one as long as it has the conductivity for lithium ions, examples of the solid electrolyte which can be used include a sulfide solid electrolyte, an oxide solid electrolyte, a nitride solid electrolyte, and a halide solid electrolyte.

Examples of the sulfide solid electrolyte include Li₂S—P₂S₅, and Li₂S—P₂S₅—LiI. The sulfide solid electrolyte may have an argyrodite type crystal structure.

Examples of the oxide solid electrolyte include a NASICON type oxide, a garnet type oxide, and a perovskite type oxide. Examples of the NASICON type oxide include oxides containing Li, Al, Ti, P, and O (for example, Li_{1.5}Al_{0.5}Ti_{1.5}(PO₄)₃). Examples of the garnet type oxide include oxides containing Li, La, Zr, and O (for example, Li₇La₃Zr₂O₁₂). Examples of the perovskite type oxide include oxides containing Li, La, Ti, and O (for example, LiLaTiO₃).

The average particle size of the solid electrolyte included in the solid electrolyte layer 40 is equivalent to or smaller than the average particle size of the positive electrode active material included in the positive electrode active material layer 22. A ratio D_{50SE}/D_{50Cathode} between the average particle size D_{50SE} of the solid electrolyte and the average particle size D_{50Cathode} of the positive active material may fall within a range of more than 0.1 and 1.0 or less. The average particle size of the solid electrolyte may fall, for example, within a range of 0.5 μm or more and 10 μm or less.

The solid electrolyte layer 40 may include a binder. The binder is not limited to particular one, and a binder which is used in the solid electrolyte layer in a general solid-state secondary battery can be used.

The solid electrolyte layer 40 may have an inner porous substrate. As the porous substrate, for example, a woven or nonwoven fabric can be used. The solid electrolyte having an inner porous substrate has high strength.

The intermediate layer 50 has electron conductivity, and pores through which lithium metal can pass. The intermediate layer 50 with such pores has such a degree of flexibility that it can follow changes in the thickness of the negative electrode layer 30 during charging and discharging. Therefore, even when the solid-state secondary battery 1 is repeatedly charged and discharged, the interfacial adhesion of each layer in the electrode laminate 10 can be maintained, and the durability of the solid-state secondary battery 1 can be enhanced.

The intermediate layer 50 may include a material having the conductivity for the lithium metal and a material having the electron conductivity. As the material having the conductivity for the lithium metal, for example, amorphous carbon particles can be used. As the material having the electron conductivity, for example, a metal can be used. The metal may be in the form of particles. The metal particles may be included in the intermediate layer 50 in the state of a mixture with the amorphous carbon particles, or may be included in the intermediate layer 50 in the state of being supported on the amorphous carbon particles. The metal may be placed, in a form of film, on each surface of the amorphous carbon particles, or the amorphous carbon particles may be impregnated with the metal.

As the amorphous carbon particles, for example, easily graphitizable carbon (soft carbon) or hardly graphitizable carbon (hard carbon) can be used. Specific examples of the amorphous carbon particles include carbon blacks such as acetylene black, furnace black, and Ketjen black, coke, activated carbon, carbon nanotube (CNT), fullerene, and graphene. Some of carbon atoms in the amorphous carbon particles are substituted with atoms such as B, P, S, O, and N by a chemical treatment such as a gas phase method or a liquid phase method.

As the metal included in the intermediate layer 50, particles in a range of a metal which forms an alloy with lithium or an intermetallic compound can be used. Examples of the metal which forms an alloy with lithium or an intermetallic compound include Ag, Au, Pt, Pd, Si, Al, Bi, Sn, Zn, Ga, and In.

When the intermediate layer 50 includes a mixture of the amorphous carbon particles and the metal particles, the average particle size of the mixture may be smaller than the average particle size of the solid electrolyte included in the solid electrolyte layer 40. In this way, the intermediate layer 50 can enter a gap between the solid electrolytes which are present on the interface of the solid electrolyte layer 40, and thus the developed area ratio of a contact interface between the solid electrolyte layer 40 and the intermediate layer 50 can be increased and the adhesion between the solid electrolyte layer 40 and the intermediate layer 50 can be enhanced. The average particle size of the amorphous carbon particles may fall, for example within a range of 0.02 μm or more and 0.06 μm or less. The average particle size of the metal particles may fall, for example, within a range of 0.06 μm or more and 0.1 μm or less.

The exterior housing body 60 can be expanded and contracted as the thickness of the negative electrode layer 30 is changed by charging and discharging. As the material of the exterior housing body 60, a laminate film can be used. As the laminate film, a laminate film having a three-layer structure can be used in which an inner resin layer, a metal layer, and an outer resin layer are laminated in this order from the inside. The outer resin layer may be, for example, a polyamide (nylon) layer, or a polyethylene terephthalate (PET) layer, the metal layer may be, for example, an aluminum layer, and the inner resin layer may be, for example, a polyethylene layer, or a polypropylene layer.

A method of manufacturing the solid-state secondary battery 1 in the present embodiment will be described. FIGS. 2 to 4 each are a diagram illustrating one step of a method of manufacturing the solid-state secondary battery according to one embodiment of the present invention. The method of manufacturing the solid-state secondary battery 1 in the present embodiment includes a first joining step, a second joining step, a densifying step, and a third joining step.

In the first joining step, as illustrated in FIG. 2, the positive electrode layer 20 with the positive electrode lead wire 25 and the solid electrolyte layer 40 are press-joined to each other to obtain a positive electrode layer-solid electrolyte layer assembly 11. The porosity of the positive electrode active material layer 22 of the positive electrode layer 20 before the joining may fall, for example, within a range of 30% or more and 50% or less. The porosity of the solid electrolyte layer 40 before the joining may fall, for example, within a range of 30% or more and 50% or less. The porosity of the positive electrode active material layer 22 before the joining may be equivalent to or different from the porosity of the solid electrolyte layer 40 before the joining. The porosity of the solid electrolyte layer 40 before the joining may fall, for example, within a range of 0.6 times or more and 1.7 times or less with respect to the porosity of the positive electrode active material layer 22 before the joining.

As a method of joining the positive electrode layer 20 and the solid electrolyte layer 40, for example, a press method can be used. As a press machine, for example, a roll press machine or a uniaxial molding press device can be used. At the time of press-joining, a joining pressure falls, for example, within a range of 50 MPa or more and 300 MPa or less, a joining time falls, for example, within a range of 0.1 seconds or more and 5 minutes or less, and a joining temperature falls, for example, within a range of 20° C. or more and 200° C. or less. A rate of decrease in porosity of the positive electrode active material layer 22 by press-joining in the first joining step may fall, for example, within a range of 10% or more and 60% or less. A rate of decrease in porosity of the solid electrolyte layer 40 may fall, for example, within a range of 10% or more and 60% or less. The rate of decrease in porosity is a value calculated by the following equation (3).

$$Rate of decrease in porosity ( \% ) = ( porosity before first joining step - porosity after first joining step ) / porosity before first joining step \times 100 \qquad ( 3 )$$

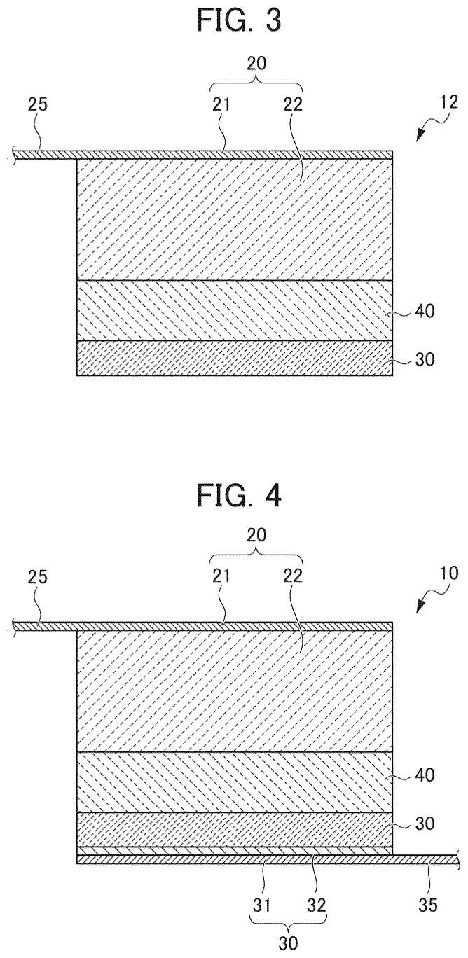

In the second joining step, as illustrated in FIG. 3, the solid electrolyte layer 40 in the positive electrode layer-solid electrolyte layer assembly 11 and the intermediate layer 50 are press-joined to each other to obtain a positive electrode layer-solid electrolyte layer-intermediate layer assembly 12. The porosity of the solid electrolyte layer 40 before the second joining may fall, for example, within a range of 25% or more and 40% or less. The porosity of the intermediate layer 50 before the second joining may fall, for example, within a range of 70% or more and 90% or less. The porosity of the solid electrolyte layer 40 before the second joining may be smaller than the porosity of the intermediate layer 50 before the second joining. The porosity of the solid electrolyte layer 40 before the second joining may fall, for example, within a range of 0.25 times or more and 0.6 times or less with respect to the porosity of the intermediate layer 50 before the second joining.

As a method of joining the solid electrolyte layer 40 in the positive electrode layer-solid electrolyte layer assembly 11 and the intermediate layer 50 in the second joining step, for example, a press method can be used. As a press machine, for example, a roll press machine or a uniaxial molding press device can be used. At the time of press-joining, a joining pressure falls, for example, within a range of 100 MPa or more and 600 MPa or less, a joining time falls, for example, within a range of 0.1 seconds or more and 5 minutes or less, and a joining temperature falls, for example, within a range of 20° C. or more and 200° C. or less. The joining pressure in the second joining step may be higher than the joining pressure in the first joining step. The joining pressure in the second joining step may fall, for example, within a range of 1.5 times or more and 12 times or less with respect to the joining pressure in the first joining step. The rate of decrease in porosity of the positive electrode active material layer 22 by press-molding in the second joining step may fall, for example, within a range of 20% or more and 80% or less. The rate of decrease in porosity of the solid electrolyte layer 40 may fall, for example, within a range of 20% or more and 80% or less. The rate of decrease in porosity of the intermediate layer 50 may fall, for example, within a range of 20% or more and 60% or less. The rate of decrease in porosity is a value calculated by the following equation (4).

$$Rate of decrease in porosity ( \% ) = ( porosity before second joining step - porosity after second joining step ) / porosity before second joining step \times 100 \qquad ( 4 )$$

In the densifying step, the positive electrode layer-solid electrolyte layer-intermediate layer assembly 12 obtained in the second joining step is press-molded in the thickness direction to be densified. As a method of joining the positive-electrode layer-solid electrolyte layer-intermediate layer assembly 12, for example, an isostatic press method can be used. As a press machine, a cold isostatic press machine (CIP) or a hot isostatic press machine (HIP) can be used. At the press-molding, a molding pressure falls, for example, within a range of 600 MPa or more and 1200 MPa or less, a molding time falls, for example, within a range of 0.1 seconds or more and 5 minutes or less, and a molding temperature falls, for example, within a range of 60° C. or more and 200° C. or less. The molding pressure in the densifying step may be higher than the joining pressure at the time of press-joining in each of the first joining step, the second joining step, and the third joining step. The molding pressure in the densifying step may fall, for example, within a range of two times or more and 24 times or less with respect to the joining pressure in the first joining step. The molding pressure in the densifying step may fall, for example, within a range of 1.1 times or more and 12 times or less with respect to the joining pressure in the second joining step. The molding pressure in the densifying step may fall, for example, within a range of 1.2 times or more and 20 times or less with respect to the joining pressure in the third joining step.

The rate of decrease in porosity of the positive electrode active material layer 22 by press-molding in the densifying step may be, for example, 77% or more, or may fall, for example, within a range of 80% or more and 95% or less. The rate of decrease in porosity of the solid electrolyte layer 40 may be, for example, 85% or more, or may fall, for example, within a range of 88% or more and 95% or less. The rate of decrease in porosity of the intermediate layer 50 may fall, for example, within a range of 0% or more and 30% or less. The rate of decrease in porosity is a value calculated by the above-described equation (1).

The densification of the positive electrode layer-solid electrolyte layer-intermediate layer assembly 12 is advanced by the densification step. The porosity of each of the positive electrode active material layer 22 and the solid electrolyte layer 40 in the positive electrode layer-solid electrolyte layer-intermediate layer assembly 12 after the densification step may be 5% or less. When the densification of the intermediate layer 50 is excessively advanced, the electrical characteristics of the electrode laminate 10 may decrease. Therefore, the densification may be performed such that the porosity of the intermediate layer 50 after the densifying step falls within a range of 40% or more and 70% or less. In addition, the densification may be performed such that the composite modulus of elasticity of the intermediate layer 50 after the densifying step is less than 1 GPa.

In the third joining step, as illustrated in FIG. 4, the intermediate layer 50 in the positive electrode layer-solid electrolyte layer-intermediate layer assembly 12 and the negative electrode layer 30 with the negative electrode lead wire 35 are press-joined to each other to obtain the electrode laminate 10.

As a method of joining the intermediate layer 50 and the negative electrode layer 30, for example, a press method can be used. As a press machine, for example, a roll press machine or a uniaxial molding press device can be used. At the time of press-joining, a joining pressure falls, for example, within a range of 60 MPa or more and 500 MPa or less, a joining time falls, for example, within a range of 0.1 seconds or more and 5 minutes or less, and a joining temperature falls, for example, within a range of 20° C. or more and 200° C. or less. The joining pressure in the third joining step may be higher than the joining pressure in the first joining step and may be lower than the joining pressure in the second joining step. The joining pressure in the third joining step may fall, for example, within a range of 1.2 times or more and 10 times or less with respect to the joining pressure in the first joining step. The joining pressure in the third joining step may fall, for example, within a range of 0.1 times or more and 0.9 times or less with respect to the joining pressure in the second joining step.

By the above-described manufacturing method, the electrode laminate 10 is obtained which includes the positive electrode layer 20 including the positive electrode current collector 21 and the positive electrode active material layer 22, the negative electrode layer 30 including the negative electrode current collector 31 facing the positive electrode active material layer 22, the solid electrolyte layer 40 placed between the positive electrode layer 20 and the negative electrode layer 30, and the intermediate layer 50 placed between the negative electrode layer 30 and the solid electrolyte layer 40, in which each of the positive electrode layer 20, the solid electrolyte layer 40, the intermediate layer 50, and the negative electrode layer 30 is joined to an adjacent layer.

The solid-state secondary battery 1 can be manufactured as follows. The positive electrode terminal 26 is connected to the positive electrode lead wire 25 of the obtained electrode laminate 10, and the negative electrode terminal 36 is connected to the negative electrode lead wire 35 of the electrode laminate 10. Then, the electrode laminate 10 is housed in the exterior housing body 60 and the exterior housing body 60 is sealed such that the end portions of the positive electrode terminal 26 and the negative electrode terminal 36 protrude.

In the method of manufacturing the solid-state secondary battery 1 of the present embodiment configured as described above, the positive electrode layer-solid electrolyte layer-intermediate layer assembly 12 obtained in the second joining step is press-molded in the thickness direction to be densified in the densifying step, and the adhesion at the contact interface of each layer of the positive electrode active material layer 22, the solid electrolyte layer 40, and the intermediate layer 50 is enhanced. The positive electrode active material layer 22 after the third joining step has a porosity that falls within the range described above and has a high density, and thus the electric capacity is increased. Furthermore, the solid electrolyte layer 40 after the third joining step has a porosity that falls within the range described above and has a high density, and thus the conductivity for charge transfer media is enhanced. The solid-state secondary battery 1 thus obtained has a low internal resistance and a high charge and discharge capacity.

In the method of manufacturing the solid-state secondary battery 1 of the present embodiment, in a case where the press-molding pressure in the densifying step satisfies the above-described conditions, in the densifying step, the porosity of each layer of the positive electrode active material layer 22, the solid electrolyte layer 40, and the intermediate layer 50 is further reduced and the adhesion at the contact interface of each layer is further enhanced. In a case where, after the densifying step, the rate of decrease in porosity of the positive electrode active material layer 22 and the rate of decrease in porosity of the solid electrolyte layer 40 fall within the respective ranges described above, the positive electrode active material layer 22 and the solid electrolyte layer 40 each have a high density. Therefore, an effective reaction area in the positive electrode active material layer 22 and the solid electrolyte layer 40 increases, causing the adhesion of each layer interface to be enhanced, and thus the solid-state secondary battery 1 thus obtained has a lower internal resistance, thus achieving a higher charge and discharge capacity. Furthermore, in a case where the press-molding temperature in the densifying step falls within the range described above, in the densifying step, the porosity of each layer of the positive electrode active material layer 22, the solid electrolyte layer 40, and the intermediate layer 50 is further reduced, and the adhesion at the contact interface of each layer is enhanced more reliably. Still furthermore, in a case where the press-molding in the densifying step is performed by the isostatic press method, in the densifying step, the porosity of each layer of the positive electrode active material layer 22, the solid electrolyte layer 40, and the intermediate layer 50 is uniformly reduced, and the adhesion at the contact interface of each layer is uniformly enhanced.

In the method of manufacturing the solid-state secondary battery 1 of the present embodiment, in a case where the press-joining pressure in the second joining step is higher than the press-joining pressure in the first joining step, in the first joining step, the press-joining pressure is lowered, and the positive electrode layer 20 and the solid electrolyte layer 40 in the positive electrode layer-solid electrolyte layer assembly 11 are softened to leave a pressing margin, and in the second joining step, the press-joining pressure is increased, whereby a contact area between the solid electrolyte layer 40 and the intermediate layer 50 is increased in a state in which the intermediate layer 50 is soft and has appropriate pores, enabling the adhesion to be enhanced. The intermediate layer 50 in a soft state and with appropriate pores makes it easy to uniformly transfer the charge transfer media toward the entire surface of the negative electrode during charging, and thus the solid-state secondary battery 1 thus obtained has a higher charge and discharge capacity. In a case where the press-joining pressure in the third joining step is higher than the press-joining pressure in the first joining step and is lower than the press-joining pressure in the second joining step, the intermediate layer 50 and the negative electrode layer 30 can be joined to each other without excessively applying the pressure to the intermediate layer 50, and thus the intermediate layer 50 can be maintained in a state of being soft and having appropriate pores.

In the method of manufacturing the solid-state secondary battery 1 of the present embodiment, in a case where the composite modulus of elasticity of the intermediate layer 50 in the positive electrode layer-solid electrolyte layer-intermediate layer assembly 12 after the densifying step falls within the range described above, the intermediate layer 50 is soft, and thus a contact area of each of an interface between the solid electrolyte layer 40 and the intermediate layer 50 and an interface between the intermediate layer 50 and the negative electrode layer 30 increases, enabling the adhesion to be enhanced. The intermediate layer 50 follows the expansion and contraction of the negative electrode layer 30 during charging and discharging, so that the positive electrode layer 20 and the negative electrode layer 30 can perform a uniform reaction in an in-plane direction and a thickness direction. Therefore, the solid-state secondary battery 1 thus obtained can have a lower internal resistance, and can achieve current concentration suppression and short circuit prevention. In the method of manufacturing the solid-state secondary battery 1 of the present embodiment, in a case where the porosity of the intermediate layer 50 in the positive electrode layer-solid electrolyte layer-intermediate layer assembly 12 after the densifying step falls within the range described above, the electrode laminate 10 in which the intermediate layer 50 has pores can be obtained. The intermediate layer 50 having pores is flexible, and thus the intermediate layer 50 can follow changes in the thickness of the negative electrode layer during charging and discharging. Therefore, in the solid-state secondary battery 1 thus obtained, the internal resistance is stably reduced, thus achieving a stably high charge and discharge capacity.

In the method of manufacturing the solid-state secondary battery 1 of the present embodiment, in a case where the intermediate layer 50 includes amorphous carbon particles, the conductivity for charge transfer media in the intermediate layer is enhanced. Therefore, in the solid-state secondary battery 1 thus obtained, the internal resistance is further reduced, thus achieving a more stably high charge and discharge capacity.

Although the embodiment of the present invention has been described above, the present invention is not limited to the embodiment described above. For example, although in the present embodiment, the negative electrode layer 30 includes the metal layer 32, the metal layer 32 may be omitted so that the lithium can be deposited on the surface of the negative electrode current collector 31. Instead of the metal layer 32, a layer may be used which includes a negative electrode active material capable of absorbing and releasing lithium ions. Examples of the negative electrode active material include lithium transition metal oxides such as lithium titanate, transition metal oxides such as TiO₂, Nb₂O₃, and Won, Si, SiO, metal sulfides, metal nitrides, and carbon materials such as artificial graphite, natural graphite, graphite, soft carbon and hard carbon. In terms of enhancing the conductivity for the lithium ions, the negative electrode active material layer may arbitrarily include a solid electrolyte. The negative electrode active material layer may arbitrarily include a conductive aid to enhance the conductivity. Furthermore, in terms of developing the flexibility, the negative electrode active material layer may arbitrarily include a binder. As the solid electrolyte, the conductive aid and the binder, a solid electrolyte, a conductive aid, and a binder which are used in a general solid-state secondary battery can be used.

### EXAMPLES

The present invention will be described in detail below using Examples. However, the present invention is not limited to Examples below.

### Example 1

### (Production of Positive Electrode Layer)

As a positive electrode current collector with a positive electrode lead wire, an aluminum foil having a thickness of 15.0 μm was prepared. A mixture was prepared of 80 parts by mass of lithium-nickel-cobalt-manganese composite oxide (NCM622) as a positive electrode active material, 17 parts by mass of an argyrodite type sulfide solid electrolyte as a solid electrolyte, 2 parts by mass of carbon black as a conductive aid, and 1 part by mass of styrene-butadiene rubber (SBR) type binder as a binder. The resulting mixture was dispersed in 43 parts by mass of butyl butyrate to prepare a positive electrode active material layer slurry. The resulting positive electrode active material layer slurry was applied on one surface of the positive electrode current collector using a bar coater such that the coating weight after drying was 27 mg/cm² and then dried to form a positive electrode active material layer having a thickness of 80.0 μm, so that a positive electrode layer was produced. The porosity of the positive electrode active material layer was 45%, and the composite modulus of elasticity thereof was 0.1 GPa. The porosity of the positive electrode active material layer was obtained by the above-described equation (2). The filling rate was a percentage of a density of the molded positive electrode active material layer with respect to the true density of the positive electrode active material.

### (Production of Solid Electrolyte Layer Transfer Sheet)

A dispersion liquid of an argyrodite type sulfide solid electrolyte (average particle size: 3.0 μm) was applied on a support sheet and then dried to form an argyrodite type sulfide solid electrolyte layer having a thickness of 100 μm, so that a solid electrolyte layer transfer sheet was produced. The porosity of the solid electrolyte layer was 40%, and the composite modulus of elasticity thereof was 0.2 GPa.

### (Production of Intermediate Layer Transfer Sheet)

A mixture was prepared of 95 parts by mass in total of Sn particles (average particle size: 0.07 μm) as metal particles and acetylene black (average particle size: 0.05 μm) as amorphous carbon particles, and 5 parts by mass of a PVDF type binder as a binder. The resulting mixture was dispersed in 1,000 parts by mass of N-methyl-2-pyrrolidone (NMP) to prepare an intermediate layer slurry. The resulting intermediate layer slurry was applied on a support sheet and then dried to produce an intermediate layer transfer sheet such that a final thickness was 3.0 μm. The porosity of the intermediate layer was 82%, and the composite modulus of elasticity thereof was 0.1 GPa.

### (Production of Negative Electrode Layer)

As a negative electrode current collector with a negative electrode lead wire, a copper foil having a thickness of 10 μm was prepared. A metallic lithium foil having a thickness of 40 μm was rolled and laminated on the surface of the copper foil to produce a negative electrode layer.

### (Production of Electrode Laminate)

The solid electrolyte layer of the solid electrolyte layer transfer sheet was superimposed on the surface of the positive electrode active material layer of the positive electrode layer, and the solid electrolyte layer and the positive electrode active material layer were joined using a uniaxial molding press device under the joining conditions of a joining pressure of 90 MPa, joining time of 3 minutes, and a joining temperature of room temperature (first joining step). Then, the support sheet was peeled off from the solid electrolyte layer transfer sheet to obtain a positive electrode layer-solid electrolyte layer assembly. Next, the intermediate layer of the intermediate layer transfer sheet was superimposed on the surface of the solid electrolyte layer in the positive electrode layer-solid electrolyte layer assembly, and the intermediate layer and the solid electrolyte layer were joined using a uniaxial molding press device under the joining conditions of a joining pressure of 290 MPa, joining time of 5 minutes, and a joining temperature of room temperature (second joining step). Then, the support sheet was peeled off from the intermediate layer transfer sheet to obtain a positive electrode layer-solid electrolyte layer-intermediate layer assembly. The obtained positive electrode layer-solid electrolyte layer-intermediate layer assembly was press-molded using an isostatic press machine under the conditions of a molding pressure of 980 MPa, a molding time of 5 minutes, and a molding temperature of 120° C. to be densified (densifying step). Next, the metallic lithium foil of the negative electrode layer was superimposed on the surface of the intermediate layer in the densified positive electrode layer-solid electrolyte layer-intermediate layer assembly, and the metallic lithium foil and the intermediate layer were joined using a uniaxial molding press device under the joining conditions of a joining pressure of 180 MPa, joining time of 2 minutes, and a joining temperature of room temperature (third joining step). In this way, an electrode laminate was obtained. The joining pressure in the first joining step, the joining pressure in the second joining step, the molding pressure and the molding temperature in the densifying step, and the joining pressure in the third joining step are shown in Table 1.

### Examples 2 to 3

An electrode laminate was obtained in the same manner as in Example 1 except that the molding temperature in the densifying step was changed to the temperature shown in Table 1 described below.

### Comparative Example 1

An electrode laminate was obtained in the same manner as in Example 1 except that the molding temperature in the densifying step was set to a room temperature.

### Comparative Examples 2 to 3

An electrode laminate was obtained in the same manner as in Example 1 except that the molding temperature in the densifying step was set to a room temperature, and the molding pressure was set to a pressure shown in Table 1 described below.

TABLE 1

| | Production of electrode laminate | | | | | | | | |
|---|---|---|---|---|---|---|---|---|---|
| | | | | | | | | | Third |
| | First joining process | | | Second joining process | | | | | joining |
| | Porosity of positive | | | Composite modulus | Porosity of | | Densifying process | | process |
| | electrode active | Porosity of solid | Joining | of elasticity of | intermediate | Joining | Molding | Molding | Joining |
| | material layer | electrolyte layer | pressure | intermediate layer | layer | pressure | pressure | temperature | pressure |
| | (%) | (%) | (GPa) | (GPa) | (%) | (GPa) | (GPa) | (° C.) | (GPa) |
| Example 1 | 45 | 40 | 90 | 0.1 | 82 | 290 | 980 | 120 | 180 |
| Example 2 | 45 | 40 | 90 | 0.1 | 82 | 290 | 980 | 100 | 180 |
| Example 3 | 45 | 40 | 90 | 0.1 | 82 | 290 | 980 | 60 | 180 |
| Comparative | 45 | 40 | 90 | 0.1 | 82 | 290 | 980 | Room | 180 |
| Example 1 | | | | | | | | temperature | |
| Comparative | 45 | 40 | 90 | 0.1 | 82 | 290 | 784 | Room | 180 |
| Example 2 | | | | | | | | temperature | |
| Comparative | 45 | 40 | 90 | 0.1 | 82 | 290 | 700 | Room | 180 |
| Example 3 | | | | | | | | temperature | |

### [Evaluation]

### (Rate of Decrease in Porosity)

In each of Examples 1 to 3 and Comparative Examples 1 to 3, the rate of decrease in porosity of each of the positive electrode active material layer and the solid electrolyte layer in each of the first joining step, the second joining step, and the densifying step, and the rate of decrease in porosity of the intermediate layer in each of the second joining step and the densifying step were measured. The results are shown in Table 2.

### (Physical Properties of Electrode Laminate)

The porosity of each of the positive electrode active material layer, the solid electrolyte layer, and the intermediate layer in the electrode laminate, and the composite modulus of elasticity of the intermediate layer in the electrode laminate were measured, the electrode laminate being obtained in each of Examples 1 to 3 and Comparative Examples 1 to 3. The results are shown in Table 3 described below.

### (Battery Characteristics)

In the electrode laminate obtained in each of Examples 1 to 3 and Comparative Examples 1 to 3, the positive electrode lead wire was connected to the positive electrode terminal, and the negative electrode lead ware was connected to the negative electrode terminal. Next, the electrode laminate was housed in the exterior housing body and the exterior housing body was sealed such that the end portions of the positive electrode terminal and the negative electrode terminal protrude, so that the solid-state secondary battery was obtained. For the obtained solid-state secondary battery, a direct current resistance, a discharge capacity at 1/3C, and whether charging and discharging at 1/3C are possible were measured by the following method. Each measurement was performed at 25° C. The results are shown in Table 3 described below.

### (Direct Current Resistance)

In a charged state of SOC50 at a temperature of 25° C., a direct current resistance (Ω·cm²) was calculated by the following equation from the voltage drop ΔV (V), the current value I (A), and the positive electrode area Ac (cm²) during discharging at the current density of 15.1 mA/cm². Direct current resistance (Ω·cm²)=voltage drop ΔV (V)/current value I (A)×positive electrode area Ac (cm²)

### (Discharge Capacity at 1/3C)

The charge and discharge test was performed at a temperature of 25° C., a charging upper limit voltage of 4.3V, a discharging lower limit voltage of 2.65 V, a C rate of 1/3C, and a current density of 1.3 mA/cm². The discharge capacity after first charging was defined as an 1/3C discharge capacity.

### (Whether Charging and Discharging at 1/3C are Possible)

A case where with respect to a design capacity of 100%, the charge and discharge capacity during charging and discharging at a temperature of 25° C. and 1/3C was 95 to 105%, and a short circuit behavior did not occur during or after charging and discharging was evaluated as “A” (possible). A case where a short circuit behavior occurred during or after charging and discharging, the charge capacity was excessively large with respect to the design capacity, or a self-discharge amount is large after charging was evaluated as “B” (not possible).

TABLE 2

| | Rate of decrease in porosity (%) | | | | | | | |
|---|---|---|---|---|---|---|---|---|
| | First joining process | | Second joining process | | | Densifying process | | |
| | Positive | Solid | Positive | Solid | | Positive | Solid | |
| | electrode active | electrolyte | electrode | electrolyte | Intermediate | electrode active | electrolyte | Intermediate |
| | material layer | layer | active | layer | layer | material layer | layer | layer |
| Example 1 | 16 | 13 | 34 | 37 | 31 | 92 | 92 | 5 |
| Example 2 | 16 | 13 | 34 | 37 | 34 | 88 | 92 | 2 |
| Example 3 | 16 | 13 | 34 | 37 | 33 | 82 | 88 | 4 |
| Comparative | 16 | 13 | 34 | 37 | 30 | 76 | 84 | 7 |
| Example 1 | | | | | | | | |
| Comparative | 16 | 13 | 34 | 37 | 32 | 68 | 82 | 4 |
| Example 2 | | | | | | | | |
| Comparative | 16 | 13 | 34 | 37 | 31 | 64 | 78 | 5 |
| Example 3 | | | | | | | | |

TABLE 3

| | | | | | Battery characteristics | | |
|---|---|---|---|---|---|---|---|
| | Properties of each layer in electrode laminate | | | | 25° C., direct | | |
| | Positive | Solid | Intermediate layer | | current | 25° C., | 25° C., whether |
| | electrode active | electrolyte | Composite | | resistance | discharge | charging and |
| | material layer | layer | modulus of | | 15.1 mA/cm², | capacity | discharging |
| | Porosity | Porosity | elasticity | Porosity | 10 sec | at 1/3 C | at 1/3 C are |
| | (%) | (%) | (GPa) | (%) | (Ω · cm²) | (mAh/g) | possible |
| Example 1 | 2.0 | 2.0 | 0.8 | 54 | 15.3 | 166 | A |
| Example 2 | 3.0 | 2.0 | 0.8 | 54 | 16.7 | 166 | A |
| Example 3 | 4.5 | 3.0 | 0.8 | 54 | 17.7 | 165 | A |
| Comparative | 6.0 | 3.0 | 0.8 | 54 | 21.0 | 121 | B |
| Example 1 | | | | | | | |
| Comparative | 8.0 | 3.0 | 0.7 | 54 | 45.1 | 99 | B |
| Example 2 | | | | | | | |
| Comparative | 9.0 | 5.5 | 0.6 | 54 | 52.3 | 68 | B |
| Example 3 | | | | | | | |

The results in Tables 1 to 3 indicate that according to a manufacturing method of each of Examples 1 to 3, the rate of decrease in porosity of each of the positive electrode active material layer and the solid electrolyte layer can be increased while the rate of decrease in porosity of the intermediate layer is kept low. In the electrode laminate obtained in each of Examples 1 to 3, the porosity of the each of the positive electrode active material layer and the solid electrolyte layer is low, the porosity of the intermediate layer is suitably maintained, and thus the developed area ratio of the contact interfaces between layers are increased. Therefore, the solid-state secondary battery using this electrode laminate has a low internal resistance, thus achieving a high charge and discharge capacity. In contrast, in the manufacturing method of each of Comparative Examples 1 to 3, the rate of decrease in porosity of each of the positive electrode active material layer and the solid electrolyte layer was low. Therefore, the solid-state secondary battery using this electrode laminate obtained in each of Comparative Examples 1 to 3 had a high direct current resistance, and thus the charge and discharge capacity was low.

### EXPLANATION OF REFERENCE NUMERALS

1 Solid-state secondary battery
10 Electrode laminate
20 Positive electrode layer
21 Positive electrode current collector
22 Positive electrode active material layer
25 Positive electrode lead wire
26 Positive electrode terminal
30 Negative electrode layer
31 Negative electrode current collector
32 Metal layer
35 Negative electrode lead wire
36 Negative electrode terminal
40 Solid electrolyte layer
50 Intermediate layer
60 Exterior housing body

What is claimed is:

1. A method of manufacturing a solid-state secondary battery comprising an electrode laminate that comprises:
a positive electrode layer including a positive electrode current collector and a positive electrode active material layer;
a negative electrode layer including a negative electrode current collector facing the positive electrode active material layer;
a solid electrolyte layer placed between the positive electrode layer and the negative electrode layer; and
an intermediate layer placed between the negative electrode layer and the solid electrolyte layer,
each of the positive electrode layer, the solid electrolyte layer, the intermediate layer, and the negative electrode layer being joined to an adjacent layer,
the method comprising:
a first joining step of press-joining the positive electrode active material layer and the solid electrolyte layer to obtain a positive electrode layer-solid electrolyte layer assembly;
a second joining step of press-joining the solid electrolyte layer and the intermediate layer in the positive electrode layer-solid electrolyte layer assembly to obtain a positive electrode layer-solid electrolyte layer-intermediate layer assembly;
a densifying step of press-molding the positive electrode layer-solid electrolyte layer-intermediate layer assembly in a thickness direction to densify the assembly; and
a third joining step of press-joining the intermediate layer in the positive electrode layer-solid electrolyte layer-intermediate layer assembly, and the negative electrode layer to obtain the electrode laminate,
wherein a porosity of each of the positive electrode active material layer and the solid electrolyte layer after the third joining step is 5% or less.

2. The method of manufacturing a solid-state secondary battery according to claim 1, wherein a press-molding pressure in the densifying step is higher than a press-joining pressure in each of the first joining step, the second joining step, and the third joining step.

3. The method of manufacturing a solid-state secondary battery according to claim 1, wherein a press-joining pressure in the second joining step is higher than a press-joining pressure in the first joining step.

4. The method of manufacturing a solid-state secondary battery according to claim 1, wherein a press-joining pressure in the third joining step is higher than a press-joining pressure in the first joining step and is lower than a press-joining pressure in the second joining step.

5. The method of manufacturing a solid-state secondary battery according to claim 1, wherein a rate of decrease in porosity of the positive electrode active material layer by press-molding in the densifying step is 77% or more, and a rate of decrease in porosity of the solid electrolyte layer by the press-molding is 85% or more.

6. The method of manufacturing a solid-state secondary battery according to claim 1, wherein a press-molding temperature in the densifying step falls within a range of 60° C. or more and 200° C. or less.

7. The method of manufacturing a solid-state secondary battery according to claim 1, wherein the press-molding in the densifying step is performed by an isostatic press method.

8. The method of manufacturing a solid-state secondary battery according to claim 1, wherein a composite modulus of elasticity of the intermediate layer in the positive electrode layer-solid electrolyte layer-intermediate layer assembly after the densifying step is less than 1 GPa.

9. The method of manufacturing a solid-state secondary battery according to claim 1, wherein a porosity of the intermediate layer in the positive electrode layer-solid electrolyte layer-intermediate layer assembly after the densifying step falls within a range of 40% or more and 70% or less.

10. The method of manufacturing a solid-state secondary battery according to claim 1, wherein the intermediate layer includes amorphous carbon particles.
